(19) United States
(12) Patent Application Publication
(10) Pub. No.: US 2018/0017111 A1
(43) Pub. Date: Jan. 18, 2018

(54) CLUTCH SYSTEM

(71) Applicant: SCHAEFFLER TECHNOLOGIES AG & CO. KG, Herzogenaurach (DE)

(72) Inventors: Jens BOHNEN, Hausach (DE); Florian VOGEL, Buehl (DE); Markus HAUSNER, Baden-Baden (DE); Philippe WAGNER, Souffelweyersheim (FR)

(73) Assignee: Schaeffler Technologies AG & Co. KG, Herzogenaurach (DE)

(21) Appl. No.: 15/545,211

(22) PCT Filed: Jan. 21, 2015
(86) PCT No.: PCT/DE2015/200010

§ 371 Date: Jul. 20, 2017

(51) Int. Cl. F16D 13/70; F16D 13/75; F16D 13/58; F16D 25/12; B60K 23/02

(52) U.S. Cl. CPC F16D 13/70; F16D 25/12; B60K 23/02; F16D 13/583; F16D 13/75

(57) ABSTRACT

The present disclosure relates to a clutch system having a clutch device and a fluid actuating device to engage and/or disengage the clutch device, the clutch device having at least one counter-pressure plate, at least one clutch cover with at least one diaphragm spring pivotably supported on the clutch cover at a swivel radius, and at least one contact plate which is movable in the axial direction of the clutch device by the diaphragm spring to frictionally clamp a clutch disk between the contact plate and the counter-pressure plate, wherein the diaphragm spring acts on the contact plate at an effective radius located outside the swivel radius in the radial direction of the clutch device and is actuatable at an actuation radius located inside the swivel radius in the radial direction by the actuating device.

### CROSS-REFERENCE TO RELATED APPLICATIONS

This application is the U.S. National Phase of PCT Appln. No. PCT/DE2015/200010 filed Jan. 21, 2015, the entire disclosure of which is incorporated by reference herein.

### TECHNICAL FIELD

The present disclosure relates to a clutch system having a clutch device, in particular having a friction clutch for a drivetrain of a motor vehicle.

### BACKGROUND

From the older, not previously published DE 10 2014 211 468.3 a clutch device is known, having a counter-pressure plate, a clutch cover with a diaphragm spring which is mounted so that it can swivel on a swivel radius, and a contact plate that is movable in an axial direction of the clutch device to an extent limited by the diaphragm spring, to frictionally clamp a clutch disk between the contact plate and the counter-pressure plate. The diaphragm spring acts on the contact plate at an effective radius located outside of the swivel radius in the radial direction of the clutch device, and is actuatable at an actuation radius located inside the swivel radius in the radial direction by an actuating device, for example a clutch release system, more precisely a throw-out bearing of the clutch release system. In general, the transmission ratio of the clutch device, more precisely the transmission ratio of the pressure plate assembly, iDP, is defined as: iDP=(swivel radius−actuation radius)/(effective radius−swivel radius). The pressure plate assembly is a pre-assemblable sub-assembly of the clutch device, that is, of the actual friction clutch, and usually comprises all components of the clutch system except the counter-pressure plate and the clutch disk.

In DE 10 2014 211 468.3, in order to be able to change the transmission ratio of the clutch device or of the pressure plate assembly without exchanging the clutch cover, a clutch cover is proposed having two concentric, ring-shaped beads to receive a corresponding wire ring, which forms a part of the swivel-mounting of the diaphragm spring. If the swivel-mounting of the diaphragm spring is formed by means of the wire ring, which is inserted into the receiving bead which is positioned inside in the radial direction, a lower transmission ratio of the pressure plate assembly iDP is possible. If the swivel-mounting of the diaphragm spring is formed by means of the wire ring, which is inserted into the receiving bead which is positioned outside in the radial direction, a higher transmission ratio of the pressure plate assembly iDP is possible. Known transmission ratios of the pressure plate assembly lie between 2.6 and 4.5, in particular between 3.1 and 4.

In the past, the clutch device and the actuating device were optimized independently of one another. For the clutch device, this meant that the transmission ratio of the pressure plate assembly in a range from 2.6 to 4.5 was regarded as standard in the automobile industry, in particular also because among the automobile manufacturers the clutch device and the actuating device are usually assigned to different subject areas which are developed separately from one another. The clutch device is usually assigned to the subject area of the drivetrain, while the actuating device is usually assigned to the subject area of the chassis. Thus, an optimal design of the entire clutch system, consisting of the clutch device and the actuating device, has not yet occurred to date.

### SUMMARY

It is the object of this disclosure to specify a possibility for optimizing a clutch system globally.

According to this disclosure, this object is fulfilled by a clutch system according to the claims, having a clutch device and a fluid actuating device to engage and/or disengage the clutch device, the clutch device having at least one counter-pressure plate, at least one clutch cover with at least one diaphragm spring swivel-mounted on a swivel radius, and at least one contact plate which is movable to a limited extent in the axial direction of the clutch device by the diaphragm spring, to frictionally clamp a clutch disk between the contact plate and the counter-pressure plate, wherein the diaphragm spring acts on the contact plate at an effective radius located outside the swivel radius in the radial direction of the clutch device, and is actuatable at an actuation radius located inside the swivel radius in the radial direction by the actuating device, where iDP=(swivel radius−actuation radius)/(effective radius−swivel radius)>=5, and where the fluid actuating device has at least one slave cylinder acting indirectly or directly on the diaphragm spring, having a slave piston, and having at least one master cylinder fluid-connected to the slave cylinder, having a master piston, where in regard to the piston surfaces iH=(area of slave piston)/(area of master piston), where 1.5<=iH<=3.5. This makes it possible to increase the efficiency of the entire clutch system, by reducing the travel distance losses in the fluid actuating device.

In reference to the distance-related efficiency of the entire clutch system, the following effects result for the clutch system:

Deflection of the diaphragm spring tongues: during disengagement, the actuating device imposes the disengaging force on the diaphragm spring via the diaphragm spring tongues. As this occurs, the diaphragm spring tongues are deflected in the axial direction until their spring force corresponds to the spring force of the disengaging force present. The distance expended for this purpose is not converted to separation according to the transmission ratio of the clutch device or of the pressure plate assembly, but must be supplied in addition. This loss of travel distance can be reduced by stiffer diaphragm spring tongues and/or lesser disengaging forces. According to the invention, at a higher transmission ratio of the pressure plate group the disengaging force is smaller, which reduces the deflection of the diaphragm spring tongues.

Cover springing: in the engaged state of the clutch device, known as the operating point, the force rim of the diaphragm spring is braced against the contact plate, more precisely on the contact plate lobes, as well as on a base on the clutch cover, which is usually formed by a wire ring that is inserted into a receiving bead on the clutch cover. The axial force acting on the clutch cover is dependent on the clamping force, and causes the clutch cover to expand, depending on the axial rigidity of the cover. During disengagement of the clutch device, the diaphragm spring is actuated in the opposite direction. As a result, the axial force acting on the clutch cover is first reduced, causing the clutch cover to be deflected into its force-free position. At the same time, the diaphragm spring bearing formed by the wire ring moves along in the axial direction on the clutch cover base, during which the disengagement travel cannot be translated into separation until the clutch cover has assumed its force-free position. During further disengagement, the diaphragm spring is preferably braced against a bearing spring on the contact plate, which is rigidly connected to the clutch cover in the axial direction and which likewise represents part of the swivel mounting of the diaphragm spring. Through the rigid tie-in of the bearing spring to the clutch cover, the disengaging force causes a further deflection of the clutch cover; this additional spring travel likewise cannot be translated into separation of the contact plate. According to the teaching of the claims, the rigidity of the clutch cover increases when the pivotable support, in particular the wire ring base, is located farther outside radially to increase the transmission ratio. The greater cover rigidity results in less deformation of the clutch cover, whereby the clutch cover as a whole can be thinner-walled, that is, less rigid, and thus can be of more economical design.

The distance-related optimization of the entire clutch system, with the increase in the transmission ratio of the clutch device or of the pressure plate assembly, also has effects on the actuating device, which is designed below preferably as a fluid actuating device for engaging and/or disengaging the clutch device.

Fluid losses due to deformation of seals and lines: when the clutch device is actuated, a pressure occurs in the actuating device that is dependent on the present disengaging force and the area of the slave piston in the slave cylinder. During disengagement, a volume of fluid is moved from the master cylinder through a fluid line into the slave cylinder. The ratio of area of slave piston to master piston yields the transmission ratio of the clutch hydraulics, iH. As a result of the prevailing pressure, deformations occur in the seals and fluid lines, independent of the rigidity of the particular components. These deformations are accompanied by a volume increase, which is filled by the fluid volume moved from the master cylinder. Thus only part of the fluid volume moved from the master cylinder arrives in the slave cylinder and can be used there to actuate the clutch device. So in comparison to an ideally rigid fluid actuating system, part of the possible stroke of the master cylinder remains unused due to the pressure-dependent lost volume. These travel losses can be reduced by smaller pressure-dependent lost volumes and/or a smaller disengaging force and/or a larger surface of the slave cylinder. The terms fluid and hydraulics include here not only liquids, but also gases, in particular air. The same considerations apply to semi-fluid actuating devices, as well as to the rigidities in purely mechanical actuating devices.

Rigidity of the clutch pedal: the clutch pedal acts as a lever, and converts the actuating energy of the driver's foot into the actuating energy at the master cylinder. Because of its limited rigidity, the clutch pedal under pressure is deflected elastically by a distance that cannot be converted into a stroke of the master cylinder, and consequently is not available for actuating the clutch device. A smaller travel loss can be achieved by a stiffer clutch pedal and/or a smaller pedal force. In particular, the increase in the transmission ratio of the pressure plate assembly results in a reduction of the pedal force, and thus to a smaller travel loss of the clutch pedal.

Preferred exemplary embodiments of the present disclosure are explained in the claims.

The clutch cover is preferably made of a sheet metal material with a material thickness d<=5 mm. This enables the clutch cover, and with it the entire clutch system, to be produced especially economically.

The transmission ratio of the pressure plate assembly is preferably: 5.5<=iDP<=6.5. With this transmission ratio, especially small travel losses occur, without there being an excessive increase in the construction space required.

Furthermore, it is advantageous if the material thickness is: 3 mm<=d<=4.5 mm. In particular, it is advantageous if the material thickness is: 3 mm<=d<=4 mm. This makes it possible to build an especially economical clutch device, due to the reduced use of material for the clutch cover.

According to another preferred exemplary embodiment, the diaphragm spring is supported pivotably on the clutch cover in the area of the swivel radius.

It is advantageous in this case if the pivotable support on the clutch cover includes at least one wire ring and/or at least one bearing spring, against which the diaphragm spring rests on the clutch cover side and/or the contact plate side.

Furthermore, it is advantageous if the pivotable support includes hooks and/or bolts on the clutch cover, by which the diaphragm spring is attached pivotably to the clutch cover, indirectly or directly. This type of support makes especially small travel losses possible.

Furthermore, it is advantageous if the actuating device has at least one clutch pedal with a transmission ratio of 3.5<=iP<=5.5. This enables the travel losses to be reduced, in reference to the efficiency of the entire clutch system, due to the limited rigidity of the clutch pedal.

In particular, it is advantageous if the clutch pedal is equipped with an over-center spring, which reduces the maximum pedal force at the clutch pedal by 30 N to 50 N, preferably by 35 N to 45 N. This reduces the actuating forces that the driver of the vehicle must exert on the clutch pedal in order to disengage the clutch device. At the same time, the over-center spring makes it possible to optimize the travel distance losses in the clutch system.

Furthermore, it is advantageous if the clutch pedal has a maximum pedal travel of 120 mm to 160 mm, preferably 130 mm to 150 mm. In reference to the clutch system, the efficiency of the entire clutch system can thus be optimized, without resulting in differences to the driver's accustomed actuation.

Since both the friction linings of the clutch disk and also to a lesser degree the friction linings of the counter-pressure plate and the contact plate are subject to wear, due to the slip speed as the frictional grip builds up, the clutch device can preferably be provided with a wear adjusting device. The wear adjusting device is preferably a distance-based wear adjusting device. The wear adjusting device preferably has an adjusting ring, which is clampably supported in the axial direction between the contact plate and the diaphragm spring, in particular the force rim of the diaphragm spring. On its surface facing away from the diaphragm spring the adjusting ring has ramps that are situated so that they can slide on opposing ramps, which are preferably recessed into the contact plate, so that during a relative turning of the adjusting ring the ramps of the adjusting ring slide along the opposing ramps, which changes the distance between the contact plate and the surface of the adjusting ring facing away from the contact plate with which the adjusting ring is in contact on the diaphragm spring.

The adjusting ring is preferably driven by a spindle drive which may be driven by a drive pawl. If the still unadjusted clutch wear is sufficiently great, during engagement of the clutch device the tongue of the drive pawl skips past one tooth of the drive pinion of the spindle drive, causing the clutch wear to be registered, and drops into the next tooth gullet of the drive pinion at the subsequent disengagement of the clutch device, whereupon the drive pinion, and thus the entire spindle drive, is rotated by the drive pawl in the course of the further disengagement process. This rotary motion is transmitted from the spindle drive to the adjusting ring, which in turn is rotated thereby, in order to adjust for the wear previously registered by the drive pawl.

### BRIEF DESCRIPTION OF THE DRAWINGS

The present disclosure will be explained in greater detail below on the basis of preferred exemplary embodiments in combination with the associated figures. They show the following:

FIG. 1 shows a sectional view of an exemplary embodiment of a clutch system having a clutch device and an actuating device, and

FIG. 2 shows a detail view of the clutch device from FIG. 1.

### DETAILED DESCRIPTION

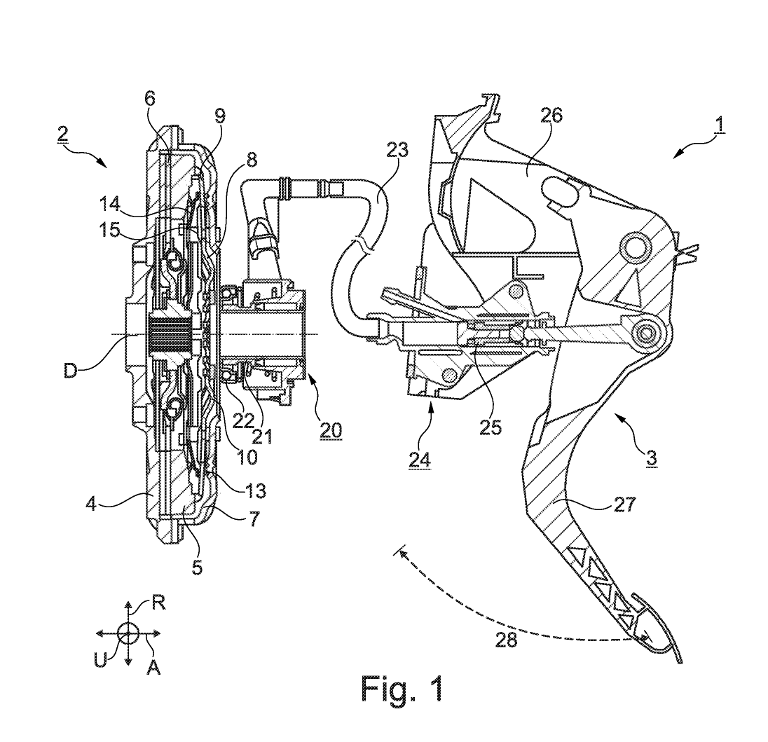

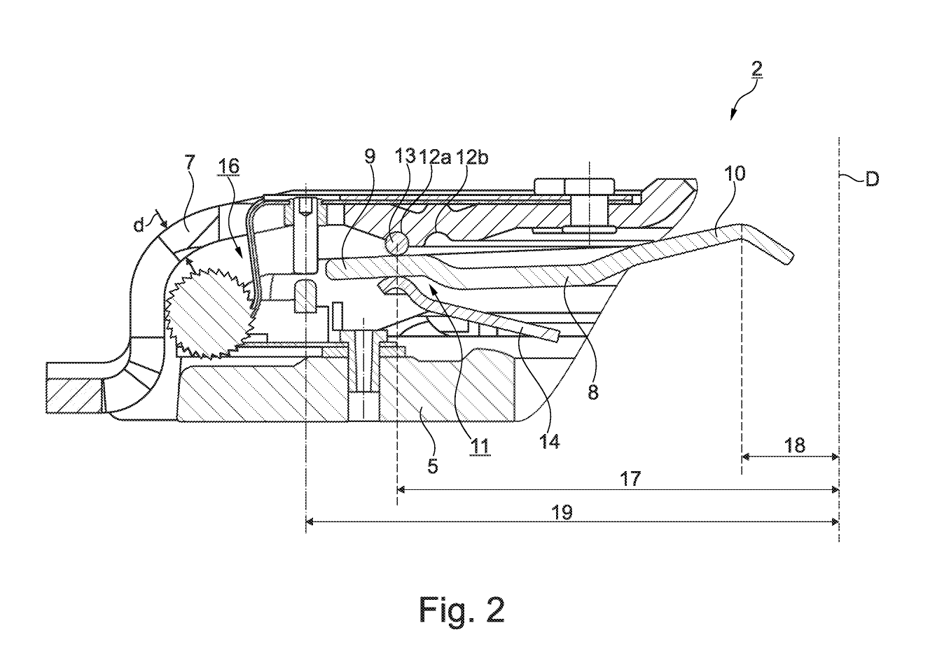

FIGS. 1 and 2 relate to a preferred exemplary embodiment of a clutch system 1 for a motor vehicle, wherein the clutch system 1 has a clutch device 2 and an actuating device 3. Features that are not identified in the present description as essential to the disclosure are to be understood as optional. The following description therefore also relates to additional exemplary embodiments of the clutch system 1 as a whole, the clutch device 2 or the actuating device 3, which have partial combinations of the features that will be explained below.

The clutch device 2 depicted in detail in FIG. 2 is part of the clutch system 1 depicted in FIG. 1. The clutch device 2 is supported so that it can rotate around an axis of rotation D, and has at least one contact plate 5, at least one counter-pressure plate 4 and at least one clutch disk 6 which is situated between the contact plate 5 and the counter-pressure plate 4 in axial direction A of the clutch device 2. The counter-pressure plate 4 is solidly connected to a clutch housing, in particular a clutch cover 7, in particular with screws. The contact plate 5 is supported non-rotatingly in the clutch cover 7, and is movable to a limited extent in axial direction A of the clutch housing 7. In particular, the contact plate 5 is attached non-rotatingly to the clutch cover 7 by means of a plurality of leaf springs (not shown) spaced apart from each other in the circumferential direction U of the clutch device 2, and is pre-tensioned away from the counter-pressure plate 4, that is, toward the right in relation to FIG. 1.

Furthermore, the clutch device 2 has a diaphragm spring 8, which is supported on the housing side or clutch cover side and is actuatable by the actuating device 3. The support on the clutch cover side may be provided, for example, by a pivotable support 11 attached to the clutch cover 7, by which the diaphragm spring 8 is tiltably suspended.

The diaphragm spring 8 is operable by the actuating device 3 by means of diaphragm spring tongues 10, which are positioned in radial direction R of the clutch device 2 on the inner side of the essentially ring-shaped diaphragm spring 8. In its radial outer area, the diaphragm spring 8 has a force rim 9. The force rim 9 may act directly on the contact plate 5 through contact plate lobes, but may also act indirectly on the contact plate 5 through an adjusting ring, which is assignable to a preferably distance-based wear adjusting device 16, as depicted in FIGS. 1 and 2.

In the normally engaged clutch device 1 depicted in FIGS. 1 and 2, in the non-actuated state the effective force of the diaphragm spring 8 outweighs the opposing force of the leaf springs, while in a normally disengaged clutch device 2 in the non-actuated state the opposing force of the leaf springs outweighs the effective force of the diaphragm spring 8. Accordingly, actuation of the diaphragm spring 8 of the normally engaged clutch device 2 results in disengagement of the clutch device 2 through tipping or swiveling of the diaphragm spring 8, that is, lifting of the contact plate 5 and distancing of the contact plate 5 from the counter-pressure plate 4, while actuation of the diaphragm spring 8 in a normally disengaged clutch device 2 results in the engaging of the clutch device 2 by tipping or swiveling the diaphragm spring 8.

With the clutch device 2 engaged, torque is transferred frictionally to the clutch disk 6 from the input side of the clutch device 2, for example from a dual-mass flywheel, through the clutch housing or clutch cover 7 and from both the counter-pressure plate 4 and the contact plate 5, both of which are connected non-rotatingly to the clutch housing or clutch cover 7. From the clutch disk 6, which is frictionally clamped between the counter-pressure plate 4 and the contact plate 5, the torque is transferred to the output side of the clutch device 2, for example to an input shaft of a transmission.

Since due to the slip speed as the frictional grip builds up, both the friction linings of the clutch plate 6 and also to a lesser degree the friction surfaces of the counter-pressure plate 4 and of the contact plate 5 are subject to wear, over the lifetime of the clutch device 2 the contact plate 5 must be moved closer and closer to the counter-pressure plate 4 in order to compensate for the loss of thickness of the friction linings and of the thickness of the friction surfaces in axial direction A, and to be able to produce frictional engagement and to engage the clutch device 2. This would change the installation position of the diaphragm spring 8. In order to compensate for this, and thus to keep the installation position of the diaphragm spring 8 constant, the wear adjusting device 16 already mentioned earlier is preferably formed in the clutch device 2.

In addition to the previously mentioned adjusting ring, the wear adjusting device 16 has a spindle drive, on which or on whose spindle shaft a drive pinion is positioned non-rotatingly. The entire spindle drive is rotatably supported by at least one spindle bearing device on the side of the contact plate 5, the spindle bearing device being joined, for example, to a side of the contact plate 5 that faces away from the clutch disk 6, in particular by screwing or riveting.

The spindle drive is connected to the adjusting ring by means of a spindle nut, a rotary motion of the spindle drive being converted to a linear motion of the spindle nut, and the linear motion of the spindle nut being converted to a rotary motion of the adjusting ring. The adjusting ring is preferably designed as a ramp ring. Ramps of the adjusting ring are situated so that they slide on opposing ramps which are formed on the side of the contact plate 5 facing away from the clutch disk, preferably recessed in the contact plate 5.

The drive pinion is provided on its circumferential surface with a tooth structure that has a certain pitch or tooth width. The drive pinion has lateral surfaces or end surfaces located opposite one another in the transverse direction of the clutch device 2, which delimit the drive pinion in the transverse direction.

A free end of a drive pawl of the wear adjusting device 16 is designed to be able to mesh essentially positively with the tooth structure of the drive pinion. For example, the drive pawl has one, two, or more than two pawl tongues extending in the direction of the drive pinion, essentially in the axial direction A of the clutch device 2, which are designed to be able to mesh positively with the tooth structure of the drive pinion, preferably alternately. If there are at least two pawl tongues, the pawl tongues preferably have a difference in length that is smaller than the pitch of the tooth structure of the drive pinion. The particular pawl tongue is preferably pre-stressed against the drive pinion in the radial direction R of the clutch device 2, so that the engagement can additionally also have a frictional component.

Alternatively or additionally, the drive pawl is pre-stressed against the drive pinion in axial direction A of the clutch device 2. To this end, the drive pawl preferably has a spring section, which gives way to the pawl tongue or tongues. The spring section of the drive pawl preferably extends essentially in radial direction R of the clutch device 2, and is connected to the clutch housing, in particular to the clutch cover 7, for example by screwing or riveting. For example, the spring section is located on the outer side of the clutch cover 7, so that the pawl tongue extends inwardly to the drive pinion through a cutout in the clutch cover 7. However, it is also possible for the spring section to be located on the inner side of the clutch cover 7.

The elastic pre-tensioning of the spring section against the clutch cover 7, or in the axial direction A of the clutch device 2, may be supported by a pre-tensioning plate. By means of a stop, which may be brought into contact or may be in contact with the force rim 9 of the diaphragm spring 8 or with the surface of the adjusting ring on the diaphragm spring side, the pre-tensioning plate may be lifted off the spring section, in order to prevent unwanted wear adjustment of and/or damage to the wear adjusting device 16, in particular to the pawl tongue when the spindle drive is blocked under axial vibrations of the contact plate 5 when the clutch device 2 is in the disengaged state. In particular, the possible relative distance between the drive pawl and the drive pinion can be limited by the stop.

If the clutch device 2 is being engaged, the contact plate 5 moves toward the counter-pressure plate 4, that is, toward the left in reference to FIG. 1. As this occurs, the free end(s) of the pawl tongue(s) slide(s) over a tooth flank of the tooth structure of the drive pinion. If there is sufficient clutch wear, the contact plate 5 must move further toward the counter-pressure plate 4, so that ultimately a free end of at least one pawl tongue skips over the tooth crest that follows the tooth flank.

During the subsequent disengagement of the clutch device 2, the free end of the aforementioned drive tongue clicks into the tooth gullet that follows the skipped tooth crest. During the disengaging motion, that is, while the contact plate 5 is moving to the right in reference to FIG. 1 under pre-tensioning of the leaf springs and the adjusting ring is under a sufficiently small clamping force, the drive pawl drives the drive pinion in a first direction of rotation, clockwise relative to FIG. 2. Together with the drive pinion, the entire spindle drive turns, converting the rotary motion into a linear motion of the spindle nut. The adjusting ring, which is under a sufficiently small clamping force during disengagement, is turned by the linearly moved spindle nut, so that the ramps of the adjusting ring move upward on the opposing ramps recessed in the contact plate 5. This causes the distance between the surface of the adjusting ring on the diaphragm spring side and the contact plate 5 to increase, until the clutch wear has been compensated for in terms of distance, in reference to the diaphragm spring 8.

During the actuation of the clutch device 2 by the actuating device 3, the possibility exist that the drive pawl turns the drive pinion of the wear adjusting device 16 in the wrong direction, that is, contrary to the clutch wear that is actually to be compensated for. Among other possibilities, this problem may occur due to axial vibrations of the contact plate 5 with the clutch device 2 disengaged or while engaging, for example if the pawl tongue is pre-tensioned too strongly against the drive pinion in the radial direction R of the clutch device 2. The wear adjusting device 16 therefore preferably has at least one locking pawl, which is designed and positioned to block the drive pinion against counter-rotation, that is, against rotating contrary to the first direction of rotation.

In the depicted exemplary embodiment, the pivotable support 11 of the diaphragm spring 8 is realized by a wire ring 13 on the clutch cover side and a bearing spring 14 on the contact plate side. The diaphragm spring 8 is thus pivotably supported in the area of its swivel radius on the clutch cover 7.

The bearing spring 14 on the contact plate side is held in axial direction A of the clutch device 2, for example by manufactured heads of diaphragm spring centering bolts 15, and pre-tensioned against the diaphragm spring 8 in the direction of the clutch cover 7. At the same time, the bearing spring 14 may be secured against rotating in circumferential direction U of the clutch device 2 by the diaphragm spring centering bolts 15. The pivotable support 11 on the clutch cover 7 thus includes at least one wire ring 13 and at least one bearing spring 14, with which the diaphragm spring 8 is in contact on the clutch cover side and/or the contact plate side. The pivotable support 11 also includes hooks and/or bolts on the clutch cover side, in particular diaphragm spring centering bolts 15, by which the diaphragm spring 8 is attached pivotably to the clutch cover 7, indirectly or directly.

Instead of the bearing spring 14, it is however also possible for example to utilize a second wire ring on the contact plate side to form the pivotable support 11 of the diaphragm spring 8. It is also possible to dispense completely with the use of wire rings, for example if the diaphragm spring centering bolts 15 or other sections of the clutch cover are provided with appropriate lobe sections, by which the diaphragm spring 8 can be pivotably supported directly.

In the exemplary embodiment depicted, two concentric receiving beads 12a, 12b are shown in the clutch cover, in which a wire ring 13 of the particular appropriate diameter may optionally be provided. In the depicted exemplary embodiment, the wire ring 13 is placed in the outer, first receiving bead 12a in radial direction R of the clutch device 2. In general, this makes a greater transmission ratio iDP of the pressure plate assembly possible than if the wire ring 13 were positioned in the second receiving bead 12b, located farther inside in radial direction R of the clutch device 2. The use of two concentrically positioned, ring-shaped receiving beads 12a, 12b therefore serves only to better explain the technical principle of the present application. So the construction principle of the pivotable support 11 of the diaphragm spring 8 is also possible for only a single receiving bead for a wire ring 13, or with some other part or section on the clutch cover which has a rolling section.

In general, the transmission ratio iDP of the pressure plate assembly, or the transmission ratio of the clutch device 2, is defined as:

iDP=(swivel radius−actuation radius)/(effective radius−swivel radius)

The swivel radius 17 defines the distance from the pivot point defined by the pivotable support 11 of the diaphragm spring 8 to the axis of rotation D of the clutch device 2. The actuation radius 18 defines the distance from the point of support of the actuating device 3, usually a throw-out bearing 22 of the actuating device 3, on the diaphragm spring 8, more precisely on the diaphragm spring tongues 10, to the axis of rotation D of the clutch device 2. The effective radius 19 defines the distance from the point of support of the diaphragm spring 8, more precisely from the point of support of the force rim 9 of the diaphragm spring 8, on the contact plate 5, usually the contact plate cams or the adjusting ring of a wear adjusting device 16 on the contact plate, to the axis of rotation D of the clutch device 2.

The diaphragm spring 8 acts on the contact plate 5 at the effective radius 19, located outside the swivel radius 17 in the radial direction R of the clutch device 2.

Furthermore, the diaphragm spring 8 is actuatable at the actuation radius 18, located inside the swivel radius 17 in the radial direction R, by the actuating device 3, more precisely the throw-out bearing 22 of the actuating device 3. The transmission ratio of the pressure plate assembly is preferably iDP>=5 (greater than or equal to 5), and in particular is preferably 5.5<=iDP<=6.5 (5.5 less than or equal to iDP less than or equal to 6.5).

The clutch cover 7 is preferably made of a sheet metal material having a material thickness of d<=5 mm (less than or equal to 5 mm). Especially preferably, the material thickness is 3 mm<=d<=4.5 mm (3 mm less than or equal to d less than or equal to 4.5 mm), by particular preference 3 mm<=d<=4 mm, which enables the clutch cover 7 and the entire clutch device 2 to be produced especially economically.

In addition to the clutch device 2, the clutch system 1 has the actuating device 3. The actuating device 3 is preferably designed as a fluid actuating device, in particular as a hydraulic or semi-hydraulic actuating device 3. On the side of the clutch device 2, the actuating device 3 has a slave cylinder 20, containing a slave piston 21 that is movable to a limited extent. The slave cylinder 20 is connected to a master cylinder 24 of the actuating device 3 by means of a fluid line 23. The master cylinder 24 contains a master piston 25 which is movable to a limited extent; lengthening the master piston 25 brings about a lengthening of the slave piston 21 by means of the fluid line 23 and the fluid displaced therein. The slave piston 21 in turn acts on the throw-out bearing 22, to disengage or engage the clutch device 2 by means of the diaphragm spring tongues 10.

On the side of the actuating device 3, a clutch pedal 27 is supported rotatably on a pedal support 26. The pedal support 26 is usually located in the legroom of the motor vehicle. Between a starting position and a maximally compressed position, the clutch pedal 27 can traverse a maximum pedal travel 28; the maximum pedal travel 28 is part of a circular path. The clutch pedal 27 is preferably equipped with an over-center spring, in order to reduce the maximum pedal force that the driver of the motor vehicle must exert with his/her foot in order to disengage the clutch device 2.

The transmission ratio of the clutch hydraulics iH is generally defined as:

iH=(area of slave piston)/(area of master piston).

Preferably, 1.5<=iH<=3.5 (1.5 less than or equal to iH less than or equal to 3.5).

According to another preferred exemplary embodiment, the clutch pedal 27 of the actuating device 3 has a transmission ratio iP, where 3.5<=iP<=5.5. With a maximum pedal travel 28 of 120 mm, at a transmission ratio of iP=3.5 the clutch pedal 27 reduces the pedal travel 28 to approximately 34 mm travel of the master piston 25. With a maximum pedal travel 28 of 120 mm, at a transmission ratio of iP=5.5 the clutch pedal 27 reduces the pedal travel 28 to approximately 22 mm travel of the master piston 25. With a maximum pedal travel 28 of 160 mm, at a transmission ratio of iP=3.5 the clutch pedal 27 reduces the pedal travel 28 to approximately 46 mm travel of the master piston 25. With a maximum pedal travel 28 of 160 mm, at a transmission ratio of iP=5.5 the clutch pedal 27 reduces the pedal travel 28 to approximately 29 mm travel of the master piston 25.

The clutch pedal 27 here preferably has a maximum pedal travel 28 of 120 mm to 160 mm, in particular preferably 130 mm to 150 mm. According to another preferred exemplary embodiment, the clutch pedal 27 is equipped with an over-center spring, which reduces the maximum pedal force at the clutch pedal by 20% to 40%, preferably by 25% to 35%. In particular, in absolute figures the maximum pedal force at the clutch pedal 27 is reduced by 30 N to 50 N, preferably by 35 N to 45 N.

The preceding exemplary embodiments relate to a clutch system 1 having a clutch device 2 and a fluid actuating device 3 to engage and/or disengage the clutch device 2, the clutch device 2 having at least one counter-pressure plate 4, at least one clutch cover 7 with at least one diaphragm spring 8 swivel-mounted on a swivel radius 17, and at least one contact plate 5 which is movable to a limited extent in the axial direction A of the clutch device 2 by the diaphragm spring 8 to frictionally clamp a clutch disk 6 between the contact plate 5 and the counter-pressure plate 4, wherein the diaphragm spring 8 acts on the contact plate 5 at an effective radius 19 located outside the swivel radius 17 in the radial direction R of the clutch device 2 and is actuatable at an actuation radius 18 located inside the swivel radius 17 in the radial direction R by the actuating device 3, where iDP=(swivel radius−actuation radius)/(effective radius−swivel radius)>=5, and where the fluid actuating device 3 has at least one slave cylinder 20 acting indirectly or directly on the diaphragm spring 8, having a slave piston 21, and having at least one master cylinder 24 fluid-connected to the slave cylinder 20, having a master piston 25, where in regard to the piston surfaces iH=(area of slave piston)/(area of master piston), where 1.5<=iH<=3.5.

### REFERENCE LABELS

1 clutch system
2 clutch device
3 actuating device
4 counter-pressure plate
5 contact plate
6 clutch disk
7 clutch cover
8 diaphragm spring
9 power rim
10 diaphragm spring tongue
11 pivotable support
12a first receiving bead
12b second receiving bead
13 wire ring
14 bearing spring
diaphragm spring centering bolt
16 wear adjusting device
17 swivel radius
18 actuation radius
19 effective radius
slave cylinder
21 slave piston
22 throw-out bearing
23 fluid line
24 master cylinder
25 master piston
26 pedal support
27 clutch pedal
28 pedal travel
d material thickness of the wall of the clutch cover
iDP transmission ratio of the pressure plate assembly
iH transmission ratio of the clutch hydraulics
iP transmission ratio of the clutch pedal
A axial direction
D axis of rotation
R radial direction
U circumferential direction

1. A clutch system comprising:
a clutch device; and
a fluid actuating device configured to engage and disengage the clutch device, the clutch device having at least one counter-pressure plate, at least one clutch cover with a diaphragm spring pivotably supported on the clutch cover at a swivel radius, and at least one contact plate movable in an axial direction of the clutch device by the diaphragm spring to frictionally clamp a clutch disk between the contact plate and the counter-pressure plate, wherein the diaphragm spring acts on the contact plate at an effective radius located outside the swivel radius in a radial direction of the clutch device and is actuatable at an actuation radius located inside the swivel radius in the radial direction by the fluid actuating device.

2. The clutch system according to claim 1, wherein the clutch cover is made of a sheet metal material having a material thickness less than or equal to 5 mm.

3. The clutch system according to claim 1, wherein a transmission ratio of the clutch device is no less than 5.5 and no greater than 6.5, where the transmission ratio is defined as (swivel radius−actuation radius)/(effective radius−swivel radius).

4. The clutch system according to claim 1, wherein the clutch cover is made of a sheet metal material having a thickness no less than 3 mm and no greater than 4 mm.

5. The clutch system according to claim 1, wherein the diaphragm spring is supported pivotably on the clutch cover by a pivotable support on the clutch cover.

6. The clutch system according to claim 5, wherein the pivotable support on the clutch cover includes at least one wire ring and at least one bearing spring, with which the diaphragm spring is in contact on a clutch cover side or a contact plate side.

7. The clutch system according to claim 5, wherein the pivotable support includes hooks or bolts on the clutch cover, by which the diaphragm spring is attached pivotably to the clutch cover.

8. The clutch system according to claim 1, wherein the fluid actuating device includes at least one clutch pedal with a transmission ratio between 3.5 and 5.5.

9. The clutch system according to claim 8, wherein the clutch pedal is equipped with an over-center spring, which reduces a maximum pedal force at the clutch pedal by 30 N to 50 N.

10. The clutch system according to claim 7, wherein the clutch pedal has a maximum pedal travel of 120 mm to 160 mm.

11. A clutch system, comprising:
a clutch device including a counter-pressure plate, a clutch cover with a diaphragm spring attached pivotally thereto, and a contact plate movable in an axial direction of the clutch device by the diaphragm spring to frictionally clamp a clutch disk between the contact plate and the counter-pressure plate; and
an actuating device configured to engage and disengage the clutch device, including a slave cylinder acting indirectly or directly on the diaphragm spring, having a slave piston, and a master cylinder fluidly-connected to the slave cylinder, having a master piston, wherein a ratio of an area of the slave piston to the master piston is between 1.5 and 3.5.

12. The clutch system of claim 11, wherein the clutch device further includes a wear adjusting device having an adjusting ring that is clampably supported in the axial direction between the contact plate and the diaphragm spring.

13. The clutch system of claim 11, wherein the diaphragm spring includes a diaphragm spring tongue positioned in a radial direction of the clutch device on an inner side of the diaphragm spring and including a force rim positioned in a radial outer area of the diaphragm spring.

14. The clutch system of claim 11, further comprising a clutch pedal supported rotatably on a pedal support on a side of the actuating device and configured to traverse a maximum pedal travel distance between a starting position and a maximally compressed position, where the maximum pedal travel distance is part of a circular path.

15. The clutch system of claim 14, wherein the clutch pedal includes a spring configured to reduce a maximum pedal force required for disengagement of the clutch device.

16. The clutch system of claim 15, wherein the spring reduces the maximum pedal force by twenty-five percent to thirty-five percent.

17. The clutch system of claim 14, wherein the maximum pedal travel distance of the clutch pedal is between 130 mm and 150 mm.

18. The clutch system of claim 11, wherein the actuating device is a fluid actuating device.
